(19) United States
(12) Patent Application Publication
(10) Pub. No.: US 2020/0171899 A1
(43) Pub. Date: Jun. 4, 2020

(54) COUPLING DEVICE COMPRISING FOUR DEGREES OF FREEDOM

(71) Applicant: LOHR ELECTROMECANIQUE, Hangenbieten (FR)

(72) Inventors: Daniel Scheer, Still (FR); Didier Ganter, Fegersheim (FR); Jean-Luc Andre, Molsheim (FR); Nicolas Sutter, Strasbourg (FR)

(21) Appl. No.: 16/614,553

(22) PCT Filed: Jun. 8, 2018
(86) PCT No.: PCT/EP2018/065196

§ 371 Date: Nov. 18, 2019

(30) Foreign Application Priority Data
Jun. 16, 2017 (FR) 1755522

(51) Int. Cl. B60D 1/48

(52) U.S. Cl. CPC B60D 1/481

(57) ABSTRACT

A coupling device includes a hitch yoke secured to a first road vehicle, and a drawbar secured to a second road vehicle. The coupling device also includes roll travel device in the drawbar for the roll travel of one vehicle relative to the other and a yaw travel device in the drawbar for the yaw travel of one vehicle relative to the other. It further includes a first pitch travel device provided such that it is secured to the hitch yoke for the pitch travel of the first road vehicle relative to the hitch yoke and a second pitch travel device in the drawbar for the pitch travel of the second road vehicle relative to the distal end of the drawbar, said second pitch travel device being separate from the first one.

### TECHNICAL FIELD

The present disclosure relates to a coupling device provided to couple two road vehicles each having at least two axles. This coupling device comprises a coupling yoke secured to one vehicle and a coupling shaft secured to the other vehicle, this coupling shaft including a coupling part provided to be locked in the coupling yoke in order to couple the two vehicles.

The disclosure more particularly relates to a coupling device having travel devices each allowing a degree of movement freedom for the vehicles, this movement preferably being damped, but without introducing a risk of failure of the coupling.

### BACKGROUND OF THE DISCLOSURE

It is known to couple two road vehicles by means of a coupling device including a coupling shaft that is fastened by each of its ends to a vehicle. One of these vehicles is typically a towing vehicle, which is motorized and which tows the second vehicle behind it, to which it is coupled, this second vehicle being referred to as following vehicle.

During turns, it is necessary for the assembly formed by the two coupled vehicles to be able to adapt to the curve of the turn, which is why this type of coupling device typically has travel means generally allowing the following vehicle to pivot in a horizontal plane relative to the towing vehicle. Reference is then made to yaw travel of one vehicle relative to the other.

When the two coupled vehicles for example travel on a road including speed bumps, they each successively tilt upward, then downward. Due to the generally rigid and non-deformable nature of the coupling shaft, it is necessary for the coupling device to include travel means generally allowing the two vehicles to pivot forward and backward relative to one another in a vertical plane. Reference is then made to pitch travel of one vehicle relative to the other.

Lastly, the two coupled vehicles for example travel on a road having potholes, in which case they may tilt sideways. Here again, it is necessary for the coupling device to include travel means generally allowing the two vehicles to pivot sideways relative to one another in a vertical plane. Reference is then made to roll travel of one vehicle relative to the other.

An autonomous vehicle is known from document WO 2007/132121 able to be coupled with another identical vehicle using a coupling device that includes several distinct travel devices. Likewise, a towing vehicle is known from document EP 2,875,971 able to be coupled with trailers using a coupling device that includes several distinct travel devices.

In the known coupling devices, the different travels described above are typically authorized by travel means that each authorize several degrees of movement freedom for the vehicles by combining several types of travels. Among the most known examples, it is possible to cite the ball or ball-and-socket coupling devices.

Generally, for space requirements reasons, these coupling devices do not make it possible to damp or stiffen the travels that they authorize when several types of travels are combined near a single articulation. Indeed, because they authorize several combined types of travels, such an articulation generally does not have enough room to equip it with damping or stiffening means for the different travels that are satisfactory in particular in terms of their reliability, passenger comfort and safety, simultaneously for the vehicles, coupling device and passengers.

Yet it is known that the absence of satisfactory damping means for the travels in particular in terms of yaw can cause dangerous behavior for the following vehicle. Thus, the yaw movements of the following vehicle can in particular be amplified by resonance effect, cause said following vehicle to drift side to side, and cause the deterioration of the coupling device, or even cause the following vehicle to tip over.

Furthermore, the known coupling devices generally provide only a pitch travel of one vehicle relative to the other. In fact, during passage over a speed bump, the pitch of one vehicle causes the pitch of the vehicle to which it is coupled, generally very uncomfortably.

These problems become even more critical in the case where more than two road vehicles are coupled in series to form a road train.

As a result, there is a need for a coupling device making it possible to address the aforementioned problems.

### SUMMARY OF THE DISCLOSURE

The object of the present embodiments therefore aims to address the drawbacks of the prior art by proposing a new coupling device having separate travel devices spaced apart from one another, which makes it possible more easily to equip each of the travel devices with a device for damping and/or slowing said travel such that each of these devices for damping and/or slowing the travel has a satisfactory damping and/or slowing level of the travel, in particular in terms of comfort, reliability and safety, and for example adapted to the case where each of the coupled vehicles transports people.

Another object of the present embodiments also aims to propose a coupling device including two pitch travel devices that are separate from one another, the two pitch axes advantageously allowing a height offset of the two vehicles.

The objects are achieved by means of a coupling device provided between a first and a second road vehicle in order to couple these two vehicles, these two vehicles each having at least two axles, said coupling device comprising a coupling yoke secured to the first road vehicle and a coupling shaft secured to the second road vehicle, the coupling shaft and the coupling yoke each including a proximal end provided to be fastened to its respective vehicle and a distal end, these distal ends being provided to be secured to one another during the coupling of the two vehicles, said coupling device being characterized in that it comprises:
a roll travel device of one vehicle relative to the other;
a yaw travel device of one vehicle relative to the other;
a first pitch travel device of the first road vehicle relative to the coupling yoke;
a second pitch travel device of the second road vehicle relative to the distal end of the coupling shaft, said second pitch travel device being separate from the first pitch travel device; and

these four travel devices all being separate and spaced apart from one another.

According to one example of implementation, the coupling device is characterized in that:
the roll travel device is provided in the coupling shaft to allow a roll travel of the second road vehicle in the longitudinal axis of the coupling shaft;
the yaw travel device is provided in the coupling shaft to allow a yaw travel of the second road vehicle along a vertical axis passing through the coupling shaft;
the first pitch travel device is provided secured to the yoke to allow a pitch travel of the first road vehicle along a first horizontal axis transverse to the longitudinal axis of the coupling shaft; and
the second pitch travel device is provided in the coupling shaft to allow a pitch travel of the second road vehicle along a second horizontal axis transverse to the longitudinal axis of the coupling shaft.

According to another example of implementation, the coupling shaft comprises at least two parts moving relative to one another and between which the roll travel device is inserted, this roll travel device comprising a horizontal shaft provided at the end of one of the parts of the coupling shaft along the longitudinal axis of the coupling shaft, this horizontal shaft being received in a receiving part provided at the end of another part of the coupling shaft, this receiving part being equipped with bearings receiving the horizontal shaft rotating around said longitudinal axis.

According to another example of implementation, the roll travel device further comprises a stiffening device that tends to return the two moving parts of the coupling shaft to a position corresponding to an absence of roll.

According to an additional example of implementation, the yaw travel device comprises a vertical pivot provided on the second vehicle and received rotating along a horizontal plane in a receiving housing provided in the coupling shaft.

According to an example of implementation, the receiving housing is provided near the proximal end of the coupling shaft.

According to another example of implementation, the vertical pivot is provided substantially near the axle of the second vehicle located as close as possible to the coupling device, this vertical pivot being offset toward the front or the rear relative to said axle by a distance smaller than 30 cm, preferably smaller than 20 cm and more preferably smaller than 10 cm.

According to an additional example of implementation, the yaw travel device comprises a yaw damping device.

According to one example of implementation, the yaw damping device comprises a horizontal track fastened to the second road vehicle and a calliper fastened to the coupling shaft, said calliper sliding with friction on the horizontal track.

According to another example of implementation, the first road vehicle comprises a drawbar including the coupling yoke, this drawbar being mounted pivoting on the first road vehicle along a first horizontal axis transverse to the longitudinal axis of the coupling shaft by at least one articulation forming a first pitch travel device.

According to an additional example of implementation, the first pitch travel device further comprises a stiffening device that tends to return the drawbar to the horizontal position.

According to an example of implementation, the stiffening device comprises a rubber block that is compressed and inserted between the bearing and the sleeve forming each articulation of the first pitch travel device.

According to another example of implementation, two vehicles are coupled by said coupling device, the distal end of the drawbar of the first road vehicle and the distal end of the coupling shaft of the second road vehicle are in contact and locked to one another such that these two distal ends are immobile relative to one another.

According to an additional example of implementation, the coupling shaft comprises at least two parts that are movable relative to one another and between which the second pitch travel device is inserted, this second pitch travel device comprising a fork provided at the end of one of the parts of the coupling shaft in a horizontal plane, the free end of each of the arms of said fork being mounted rotating on a horizontal shaft transverse to the longitudinal axis of the coupling shaft and provided on two opposite lateral flanks of another part of the coupling shaft.

According to one example of implementation, the second pitch travel device further comprises a stiffening device that tends to return the two moving parts of the coupling shaft into the same longitudinal axis.

According to another example of implementation, the stiffening device of the roll travel device and/or of the second pitch travel device comprises horizontal spring leaves fastened by one end on one of the parts of the coupling shaft, the free end of each of the spring leaves being received by sliding in a guide part provided on another part of the coupling shaft.

According to an additional example of implementation, the second pitch travel device is provided in the proximal half of the coupling shaft.

According to an example of implementation, the first and second pitch travel devices each authorize a pitch travel of the road vehicle with which they are associated along a first horizontal axis and a second horizontal axis transverse to the longitudinal axis of the coupling shaft, these two axes being parallel and located in a same horizontal plane when the two coupled vehicles themselves travel on a same horizontal plane.

According to another example of implementation, the first road vehicle is a towing vehicle and in that the second road vehicle is a following vehicle.

The objects are also achieved by means of a road vehicle provided to be coupled with another similar road vehicle by means of a coupling device as previously described in order to form a road assembly comprising at least two vehicles, characterized in that each of the vehicles of said road assembly includes a coupling yoke at a front or rear end and a coupling shaft at the other, opposite end.

According to one example of implementation, said road vehicle includes a coupling shaft in front and a coupling yoke in back.

The advantages of the present embodiments are particularly numerous.

### BRIEF DESCRIPTION OF THE DRAWINGS

Other characteristics and advantages of the present embodiments will be seen more clearly from the following description, provided with reference to the appended drawings, provided by way of non-limiting examples, in which:

FIG. 1 is a rear three-quarters bottom perspective view of two road vehicles equipped with a coupling device, these two road vehicles not being coupled;

FIG. 2 is a perspective view similar to that of FIG. 1, in which the two road vehicles are coupled using a coupling device;

FIG. 3 is a top perspective view of the coupling device, showing the different travel axes;

FIG. 4 is a vertical sectional view of the coupling shaft shown in FIG. 3;

FIG. 5 is a top perspective view of a drawbar including a coupling yoke;

FIG. 6 is a horizontal sectional view of the drawbar shown in FIG. 5;

FIG. 7 is a top perspective detail view of the coupling shaft near its travel devices;

FIG. 8 is a vertical sectional view that corresponds to FIG. 7;

FIG. 9 is a front three-quarters bottom perspective view of a road vehicle equipped with a coupling shaft in the zero pitch, roll and yaw travel position;

FIG. 10 is a perspective view illustrating the amplitude of the yaw travel device;

FIGS. 11 and 12 are perspective views illustrating the amplitude of the first pitch travel device;

FIGS. 13 and 14 are perspective views illustrating the amplitude of the first roll travel device;

FIG. 15 is a rear three-quarters bottom perspective view of a road vehicle equipped with a coupling yoke in the zero pitch travel position; and

FIGS. 16 and 17 are perspective views illustrating the amplitude of the second pitch travel device.

In these figures, for visibility reasons of the coupling device, the vehicles are shown in thinner lines than those of the coupling device.

### DETAILED DESCRIPTION

The structurally and functionally identical elements shown in several different figures are assigned the same numerical or alphanumerical reference.

The coupling device (1) is provided to be positioned between a first road vehicle (2) and an adjacent second road vehicle (3) in order to couple these two vehicles (2, 3).

The expressions “first vehicle” and “second vehicle” do not reflect any relative position, or any role, for these vehicles, but only make it possible to distinguish them from one another.

According to a first preferred embodiment, the first road vehicle (2) is a motorized towing vehicle that is positioned in front of the second road vehicle (3), which is a following vehicle.

The coupling device (1) is provided to equip vehicles (2, 3) each including at least two axles (4). It preferably involves vehicles intended to transport people.

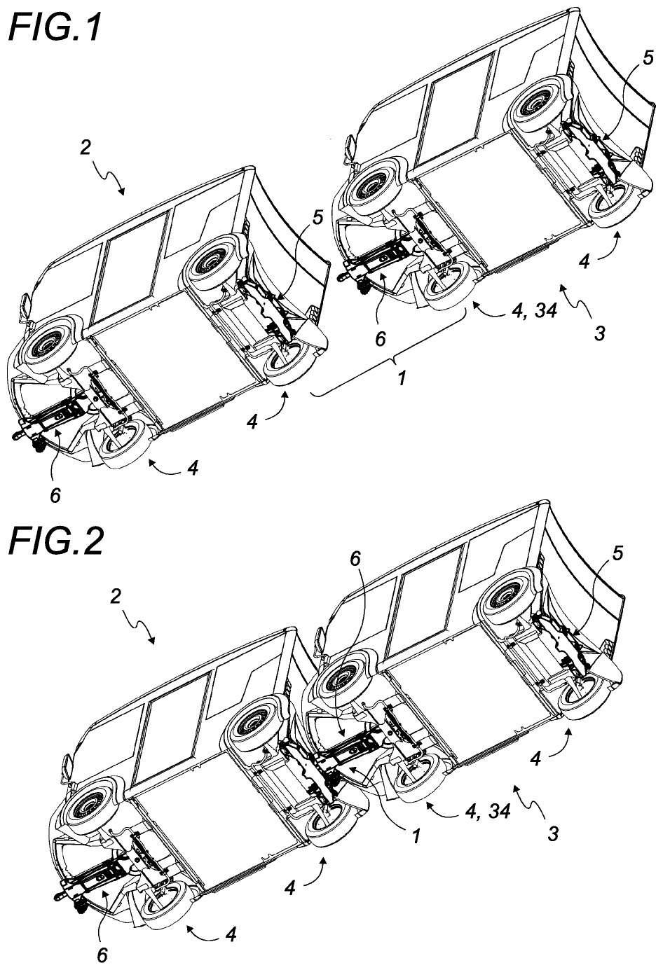

As shown in FIGS. 1 to 3, the coupling device (1) comprises a coupling yoke (5) secured to the first road vehicle (2) and a coupling shaft (6) secured to the second road vehicle (3), the coupling shaft (6) and the coupling yoke (5) each including a proximal end (7, 8) provided to be fastened to its respective vehicle and a distal end (9, 10), these distal ends (9, 10) being provided to be secured to one another during the coupling of the two vehicles (2, 3).

According to one preferred embodiment, the first and second road vehicles (2, 3) are identical, and provided to form couplings of at least two road vehicles (2, 3) one after the other in order to form a road train. Thus, the embodiments also relate to a unified road train (2, 3) including a coupling device (1), namely a coupling shaft (6) provided at one end, for example at the front end of said vehicle and a coupling yoke (5) provided at the opposite end, for example at the rear end of said vehicle.

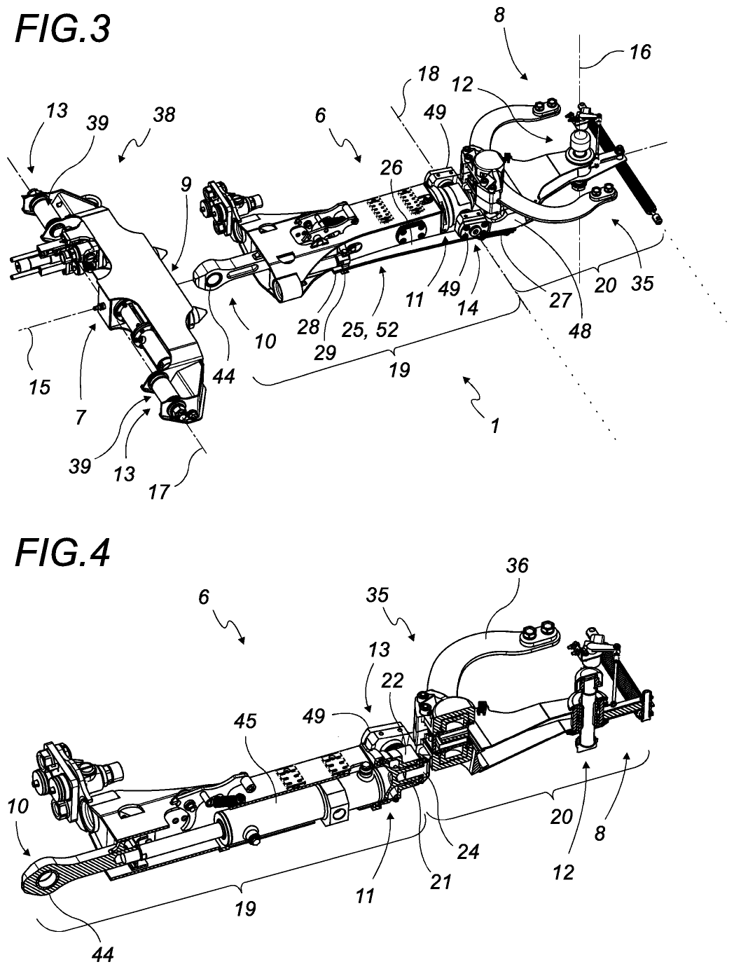

The coupling device (1) comprises four degrees of freedom shown in FIG. 3, namely one degree of yaw freedom, one degree of roll freedom and two separate degrees of pitch freedom. These four degrees of freedom are obtained owing to the following means:
a roll travel device (11) of one vehicle relative to the other;
a yaw travel device (12) of one vehicle relative to the other;
a first pitch travel device (13) of the first road vehicle (2) relative to the distal end (9) of the coupling yoke (5); and
a second pitch travel device (14) of the second road vehicle (3) relative to the distal end (10) of the coupling shaft (6), said second pitch travel device (14) being separate from the first pitch travel (13) device.

These four travel devices are preferably separate and spaced apart from one another.

In the embodiment shown in the drawings, the roll travel device (11) and the first pitch travel device (13) are close to one another and form an articulated coupling return.

According to one preferred embodiment, the roll travel device (11) is provided in the coupling shaft (6) to allow a roll travel of the second road vehicle (3) in the longitudinal axis (15) of the coupling shaft (6).

According to this preferred embodiment, the yaw travel device (12) is provided in the coupling shaft (6) to allow a yaw travel of the second road vehicle (3) along a vertical axis (16) passing through the coupling shaft (6).

Likewise, the first pitch travel device (13) is provided secured to the coupling yoke (5) to allow a pitch travel of the first road vehicle (2) along a first horizontal axis (17) transverse to the longitudinal axis (15) of the coupling shaft (6).

Lastly, the second pitch travel device (14) is provided in the coupling shaft (6) to allow a pitch travel of the second road vehicle (3) along a second horizontal axis (18) transverse to the longitudinal axis (15) of the coupling shaft (6).

The four travel devices will now be described in more detail below.

Roll Travel Device

According to one preferred embodiment, the coupling shaft (6) comprises at least two moving parts (19, 20) relative to one another and between which the roll travel device (11) is inserted.

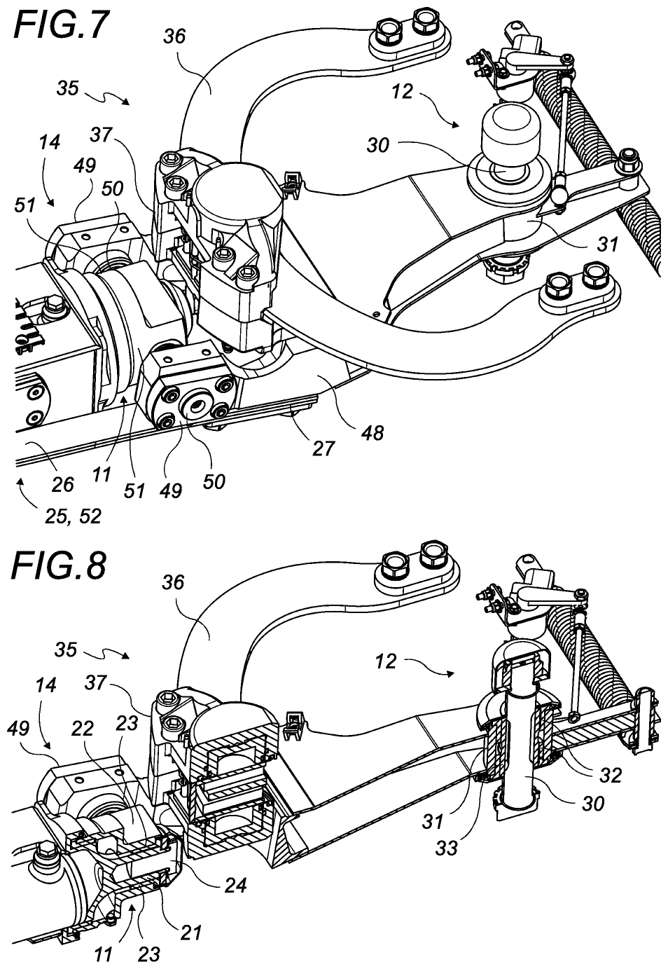

As shown in FIGS. 7 and 8, the roll travel device (11) comprises a horizontal shaft (21) provided at the end of a moving part (19) of the coupling shaft (6) along the longitudinal axis (15) of the coupling shaft (6), this horizontal shaft (21) being received rotatably in a receiving part (22) provided at the end of the other moving part (20) of the coupling shaft (6). The receiving part (22) is preferably equipped with bronze bearings (23) receiving the horizontal shaft (21) rotating around the longitudinal axis (15) of the coupling shaft (6), the horizontal shaft (21) being kept at the end by the assembly of a screw (24).

The roll travel device (11) is preferably equipped with a stiffening device (25) that tends to return the two moving parts (19, 20) of the coupling shaft (6) to a position that corresponds to an absence of roll. The stiffening device (25) of the roll travel device (11) comprises horizontal spring leaves (26) fastened by a first end (27) on one of the moving parts (19, 20) of the coupling shaft (6), the free end (28) of each of the spring leaves (26) being received slidingly in a guide part (29) provided on the other of the moving parts (20, 19) of the coupling shaft (6). This guide part (29) can be in the form of a vertical plate provided with a slit through which the spring leaves (26) slide freely. When the two moving parts (19, 20) of the coupling shaft (6) pivot relative to one another around the longitudinal axis (15) of the coupling shaft (6), these spring leaves (26) come into contact with the rims of the slit of the vertical plate and deform by resilient flexion, this resilient flexion forming a resilient return means that tends to reposition the two moving parts (19, 20) of the coupling shaft (6) according to a position where the two moving parts (19, 20) of the coupling shaft (6) are not pivoted with respect to one another, this position typically being referred to as zero roll travel.

Yaw Travel Device

According to a preferred example implementation, the yaw travel device (12) comprises a vertical pivot (30) provided on the second road vehicle (3), for example below the chassis of said second road vehicle (3), and received rotating along a horizontal plane in a receiving housing (31) provided in the coupling shaft (6).

As shown in FIGS. 7 and 8, the receiving housing (31) is preferably provided near the proximal end (8) of the coupling shaft (6) and includes bronze bearings that authorize the pivoting of the vertical pivot (30), these bronze bearings (32) being mounted on a spacer (33) that is stationary relative to the chassis of the second road vehicle (3). Said spacer (33) is therefore placed between the vertical pivot (30) and the bronze bearings (32).

The vertical pivot (30) is preferably provided substantially near the axle (34) of the second road vehicle (3) located closest to the coupling device (1), that is to say, at the front axle (34) of the second road vehicle (3) as shown in the figures. The vertical pivot (30) can be offset toward the front or toward the rear, preferably toward the rear, relative to said axle (34) by a distance of less than 30 cm, preferably less than 20 cm and more preferably less than 10 cm. This position of the yaw travel device (12) advantageously makes it possible to have the most single-track footprint possible for the coupled road vehicles (2, 3), that is to say, in order to reduce the footprint on turns of the assembly formed by the coupled road vehicles (2, 3).

According to one preferred embodiment, the vertical pivot (30) of the yaw travel device (12) passes through the front part of the chassis of the second road vehicle (3), which is also known as cradle.

The yaw travel device (12) preferably comprises a yaw damping device (35) provided to slow the yaw movements of one vehicle relative to the other.

According to one preferred embodiment, the yaw damping device (35) comprises a horizontal track (36) fastened to the second road vehicle (3) and a calliper (37) fastened to the coupling shaft (6), said calliper (37) sliding with friction on the horizontal track (36). The calliper can include an upper jaw and a lower jaw each respectively tightening on the upper surface and on the lower surface of the horizontal track (36), this friction of the calliper (37) on the horizontal track (36) slowing the pivoting of the coupling shaft (6) around the vertical pivot (30). The force of this slowing can be adjusted by modifying the gripping force of the jaws on the horizontal track (36). This device for adjusting the yaw damping device (35) can be controlled by the movement speed of the coupled vehicles (2, 3), for example gradually and proportionally, so as to harden the yaw slowing when they move at a high speed.

There is no yaw between the two road vehicles (2, 3) when the first road vehicle (2) has not pivoted relative to the second road vehicle (3) in a horizontal plane. This position is typically referred to as zero yaw travel.

First Pitch Travel Device

According to one preferred embodiment, the first road vehicle (2) comprises a drawbar (38) including the coupling yoke (5), this drawbar (38) being mounted pivoting on the first road vehicle (2) along a first horizontal axis (17) transverse to the longitudinal axis (15) of the coupling shaft (6) by at least one articulation (39), preferably two, forming a first pitch travel device (13). Thus, the coupling yoke (5) pivots relative to the first road vehicle (2) along said first horizontal axis (17) transverse to the longitudinal axis (15) of the coupling shaft (6), thus supplying a pitch means of the first road vehicle (2) with respect to the coupling yoke.

As shown in FIGS. 7 and 8, each articulation (39) preferably comprises at least one bearing (40) mounted rotating on a transverse shaft (41) provided along said first horizontal axis (17). Each articulation (39) also comprises a sleeve (42) mounted tightly fitted on each bearing (40), said sleeve (42) being fastened to the first road vehicle (2). The transverse shaft (41) is mounted rotating on the drawbar (38) by means of bearings (43).

Near its distal end (10), the coupling shaft (6) includes a coupling part (44) provided to be locked in the coupling yoke (5) in order to couple the two road vehicles (2, 3). In the drawings, as an example, the coupling part (44) is in the form of a vertical ring provided to be locked by the penetration of a horizontal shaft in its central opening when it is engaged in the coupling yoke (5).

During the coupling of the two road vehicles (2, 3), once the coupling part (44) is locked in the coupling yoke (5), the drawbar (38) and the coupling shaft (6) are preferably assembled and locked to one another so as to form a single assembly. According to one preferred embodiment, the coupling part (44) is mounted on the moving rod of a jack (45) housed in the coupling shaft (6), and this assembly is done by retracting said moving rod, so as to bring the drawbar (38) and the coupling shaft (6) closer to one another until they are abutting. The pressure in the jack is maintained such that it tends to bring the drawbar (38) and the coupling shaft (6) continuously closer to one another.

As a result, when two vehicles (2, 3) are coupled by the coupling device (1), the distal end of the drawbar (38) of the first road vehicle (2) and the distal end (10) of the coupling shaft (6) of the second road vehicle (3) are in contact and locked to one another such that these two distal ends are immobile relative to one another.

Thus, the drawbar (38) and the coupling shaft (6) are firmly anchored against one another, and the only pivoting in a vertical plane between the drawbar (38) and the coupling shaft (6) that is authorized by the coupling device (1) can be done near each articulation (39) forming the first pitch travel device (13).

According to one preferred embodiment, the first pitch travel device (13) further comprises a stiffening device (42) that tends to return the drawbar (38) to a position where the coupling yoke (5) is not pivoted relative to the first road vehicle (2), this position typically being referred to as zero pitch travel. In this zero pitch travel position, the drawbar (38) is preferably horizontal.

The stiffening device (46) can include a rubber block (47) that is compressed on the shaft (41) and inserted between the bearings (40) and the sleeve (42) of each articulation (39) of the first pitch travel device (13). This type of stiffener is also known under the name of “silent block”. It is the temporary and resilient deformation of the rubber block (47) that slows the pitch travel, this deformation tending to bring the drawbar (38) back to the zero pitch travel position.

Second Pitch Travel Device

According to one preferred embodiment, the coupling shaft (6) comprises at least two moving parts (19, 20) relative to one another and between which the second pitch travel device (14) is inserted.

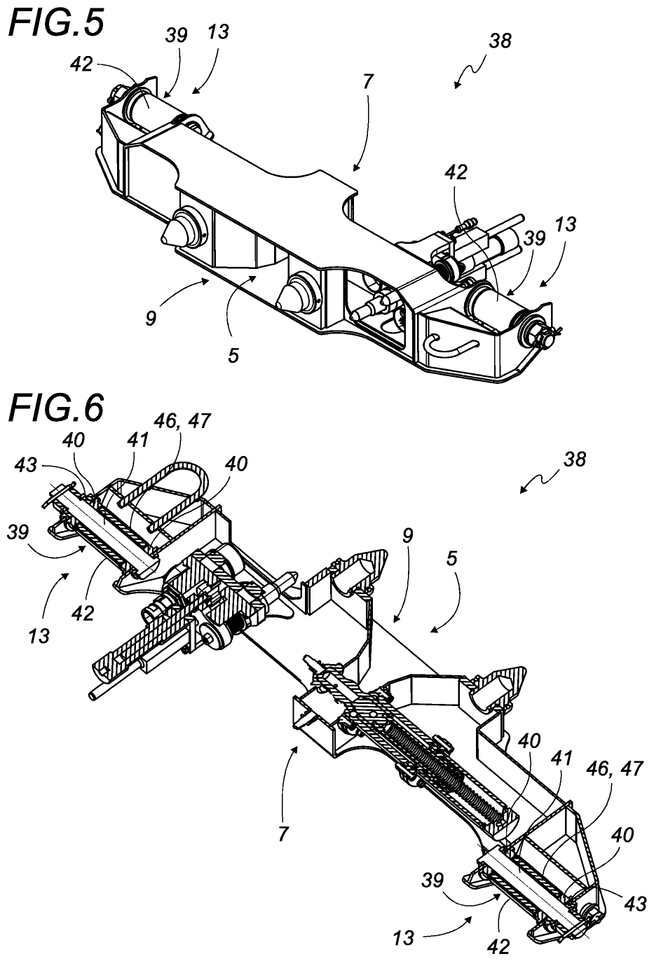

As shown in FIGS. 5 and 6, the second pitch travel device (14) can comprise a fork (48) provided at the end of a moving part (20) of the coupling shaft (6), preferably in the proximal part (20) of the coupling shaft (6), and located in a horizontal plane when the coupling shaft (6) is in the zero pitch travel position, that is to say, when the moving parts (19, 20) of said coupling shaft (6) are not pivoted relative to one another in a vertical plane.

The free end (49) of each of the arms of the fork (48) is mounted rotating on a horizontal shaft (50), which is transverse to the longitudinal axis (15) of the coupling shaft (6) and which is provided on two opposite lateral flanks (51) of the other part (19) of the coupling shaft (6), preferably in the distal part (19) of the coupling shaft (6).

According to one preferred embodiment, the second pitch travel device (14) further comprises a stiffening device (52) that tends to return the two moving parts (19, 20) of the coupling shaft (6) into the same longitudinal axis, namely the longitudinal axis (15) of the coupling shaft (6).

The stiffening device (52) of the second pitch travel device (14) and the stiffening device (25) of the roll travel device (11) are preferably constituted by the same spring leaf stiffening device (26). See the stiffening device (25) of the roll travel device (11) that is described above.

The second pitch travel device (14) is preferably provided in the proximal part (20) of the coupling shaft (6), in order to provide space for the jack (45) and the distal part (19) of the coupling shaft (6).

The first and second pitch travel devices (13, 14) each authorize a pitch travel of the road vehicle (2, 3) with which they are associated, these travels respectively being authorized along a first horizontal axis (17) and a second horizontal axis (18) that are transverse to the longitudinal axis (15) of the coupling shaft (6), these two axes (17, 18) being parallel and located in a same horizontal plane when the two coupled vehicles (2, 3) in turn travel on a same horizontal plane, which corresponds to a zero pitch travel position for the two pitch travel devices (13, 14).

The supply of two separate pitch travel devices (13, 14) advantageously allows a height offset of the two vehicles (2, 3).

The configuration of the coupling device (1) as previously described and illustrated in the figures allows travel amplitudes that meet the legal requirements regarding vehicle approval. These travel amplitudes are given in angular degrees.

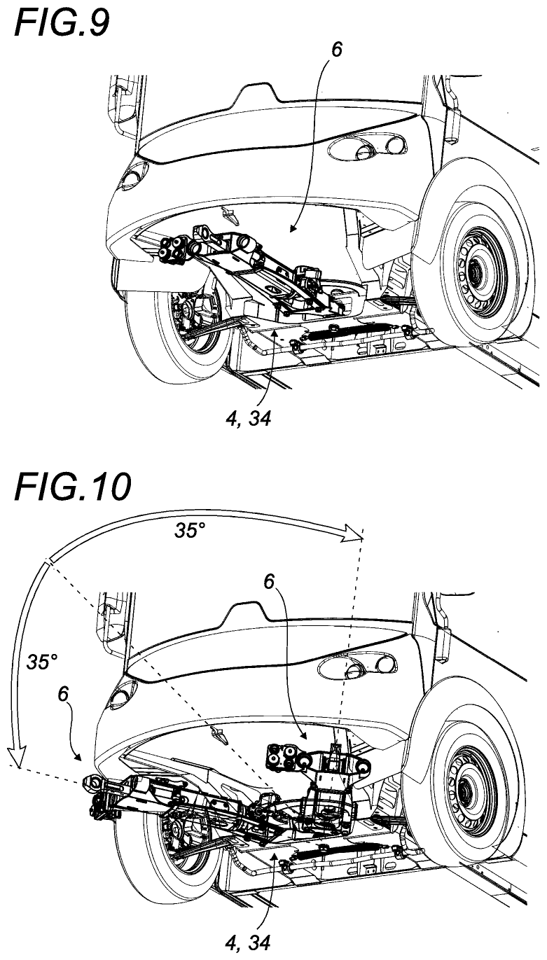

FIG. 9 shows a coupling shaft (6) in the zero pitch, roll and yaw travel position.

In FIG. 10, the coupling shaft (6) is shown in its extreme yaw travel positions. As shown in this figure, the yaw travel device (12) allows a lateral travel of the coupling shaft (6) relative to the second road vehicle (3) of about 35 degrees on either side, for a total yaw travel amplitude of about 70 degrees.

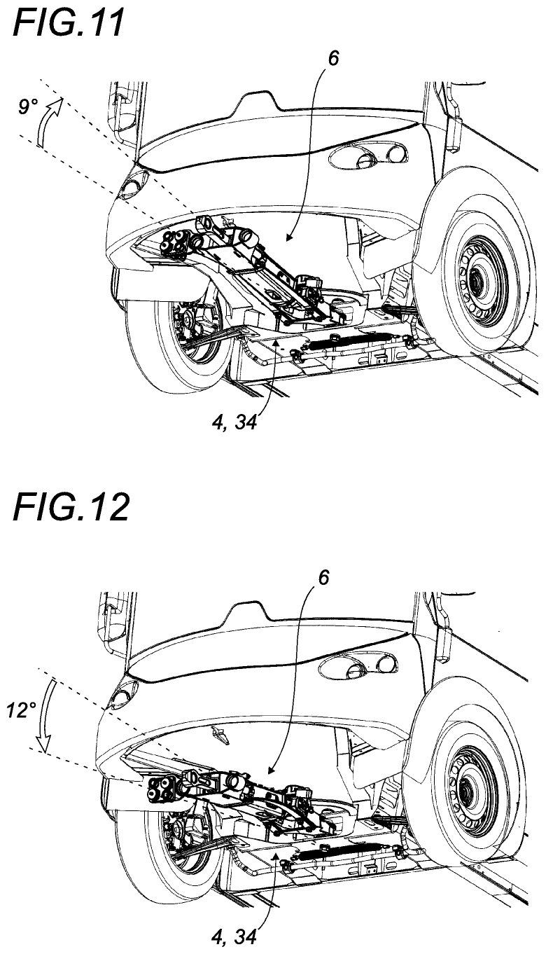

In FIGS. 11 and 12, the coupling shaft (6) is shown in its extreme pitch travel positions. As shown in these figures, the first pitch travel device (13) allows a vertical travel of the moving part (19) of the coupling shaft (6) relative to the other moving part (20) of the coupling shaft (6) by about 9 degrees upward and about 12 degrees downward, for a total pitch travel amplitude of about 21 degrees.

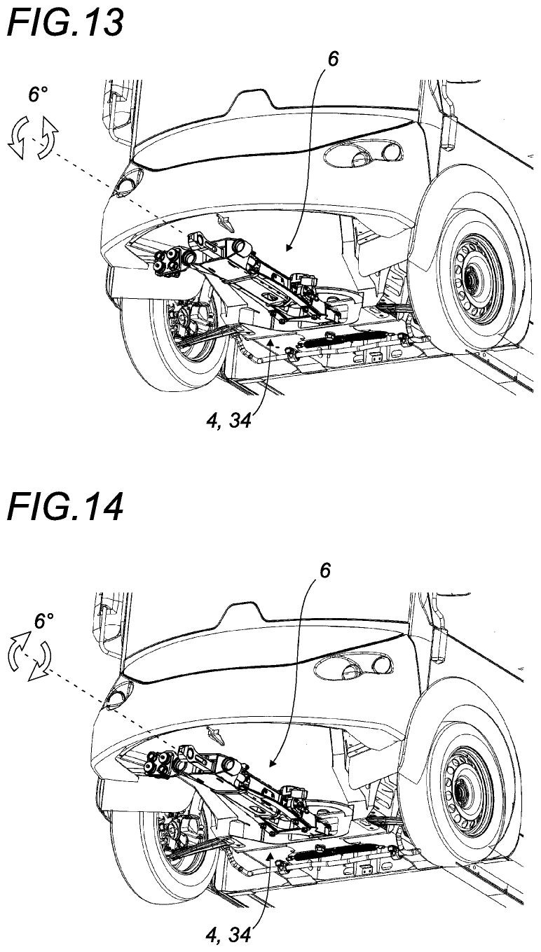

In FIGS. 13 and 14, the coupling shaft (6) is shown in its extreme roll travel positions. As shown in these figures, the roll travel device (11) allows a rotational travel of the moving part (19) of the coupling shaft (6) relative to the other moving part (20) of the coupling shaft (6) by about 6 degrees in either direction, for a total roll travel amplitude of about 12 degrees.

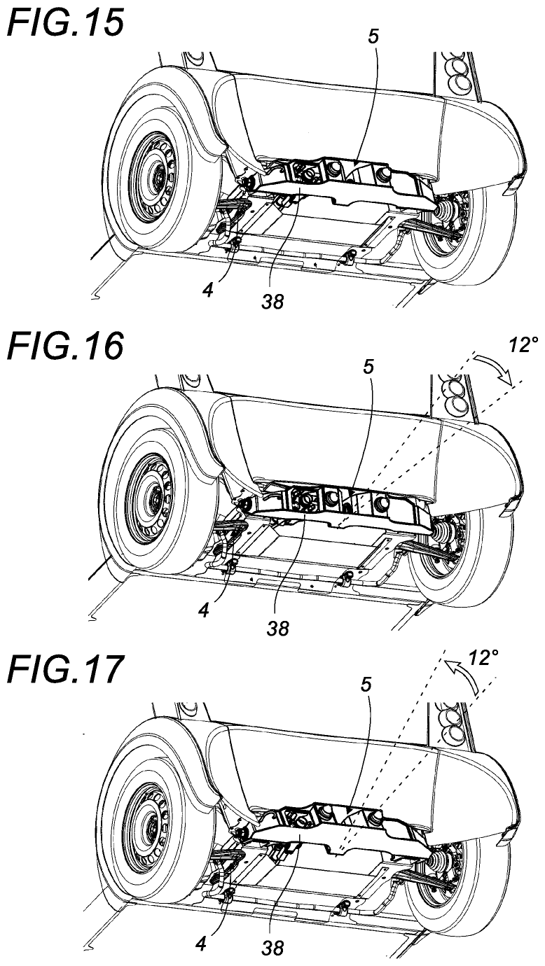

FIG. 15 shows a coupling yoke (5) in the zero pitch travel position.

In FIGS. 16 and 17, the coupling yoke (5) is shown in its extreme pitch travel positions. As shown in these figures, the second pitch travel device (14) allows a vertical travel of the coupling yoke (5) relative to the first road vehicle (2) of about 12 degrees upward and downward, for a total pitch travel amplitude of about 24 degrees.

It is of course possible for one skilled in the art to obtain greater travel amplitudes for example by modifying the configuration of the coupling device (1).

It is obvious that this description is not limited to the examples explicitly described, but also includes other embodiments and/or implementations. Thus, one described technical characteristic can be replaced by an equivalent technical characteristic without going beyond the scope of the appended claims, and a described step fot the implementation of the method can be replaced by an equivalent step without going beyond the scope of claims.

1. A coupling device provided between a first and a second road vehicle in order to couple these two vehicles, these two vehicles each having at least two axles, said coupling device comprising a coupling yoke secured to the first road vehicle and a coupling shaft secured to the second road vehicle, the coupling shaft and the coupling yoke each including a proximal end provided to be fastened to its respective vehicle and a distal end, these distal ends being provided to be secured to one another during the coupling of the two vehicles, said coupling device comprising:
a roll travel device of one vehicle relative to the other;
a yaw travel device of one vehicle relative to the other;
a first pitch travel device of the first road vehicle relative to the coupling yoke;
a second pitch travel device of the second road vehicle relative to the distal end of the coupling shaft, said second pitch travel device being separate from the first pitch travel;
these four travel devices all being separate and spaced apart from one another; and wherein the first road vehicle comprises a drawbar including the coupling yoke, this drawbar being mounted pivoting on the first road vehicle along a first horizontal axis transverse to the longitudinal axis of the coupling shaft by at least one articulation forming a first pitch travel device.

2. The coupling device according to claim 1, wherein:
the roll travel device is provided in the coupling shaft to allow a roll travel of the second road vehicle in the longitudinal axis of the coupling shaft;
the yaw travel device is provided in the coupling shaft to allow a yaw travel of the second road vehicle along a vertical axis passing through the coupling shaft;
the first pitch travel device is provided secured to the yoke to allow a pitch travel of the first road vehicle along a first horizontal axis transverse to the longitudinal axis of the coupling shaft; and
the second pitch travel device is provided in the coupling shaft to allow a pitch travel of the second road vehicle along a second horizontal axis transverse to the longitudinal axis of the coupling shaft.

3. The coupling device according to claim 2, wherein the coupling shaft comprises at least two parts moving relative to one another and between which the roll travel device is inserted, this roll travel device comprising a horizontal shaft provided at the end of one of the moving parts of the coupling shaft along the longitudinal axis of the coupling shaft, this horizontal shaft being received in a receiving part provided at the end of another part of the coupling shaft, this receiving part being equipped with bearings receiving the horizontal shaft rotating around said longitudinal axis.

4. The coupling device according to claim 3, wherein the roll travel device further comprises a stiffening device that tends to return the two moving parts of the coupling shaft to a position corresponding to an absence of roll.

5. The coupling device according to claim 2, wherein the yaw travel device comprises a vertical pivot provided on the second vehicle and received rotating along a horizontal plane in a receiving housing provided in the coupling shaft.

6. The coupling device according to claim 5, wherein the receiving housing is provided near the proximal end of the coupling shaft.

7. The coupling device according to claim 5, wherein the vertical pivot is provided substantially near the axle of the second road vehicle located as close as possible to the coupling device, this vertical pivot being offset toward the front or the rear relative to said axle by a distance smaller than 30 cm, preferably smaller than 20 cm and more preferably smaller than 10 cm.

8. The coupling device according to claim 1, wherein the yaw travel device comprises a yaw damping device.

9. The coupling device according to claim 8, wherein the yaw damping device comprises a horizontal track fastened to the second road vehicle and a calliper fastened to the coupling shaft, said calliper sliding with friction on the horizontal track.

10. The coupling device according to claim 1, wherein the first pitch travel device further comprises a stiffening device that tends to return the drawbar to the horizontal position.

11. The coupling device according to claim 10, wherein the stiffening device comprises a rubber block that is compressed and inserted between the bearings and the sleeve forming each articulation of the first pitch travel device.

12. The coupling device according to claim 1, wherein when two vehicles are coupled by the coupling device, the distal end of the drawbar of the first road vehicle and the distal end of the coupling shaft of the second road vehicle are in contact and locked to one another such that these two distal ends are immobile relative to one another.

13. The coupling device according to claim 2, wherein the coupling shaft comprises at least two parts that are movable relative to one another and between which the second pitch travel device is inserted, this second pitch travel device comprising a fork provided at the end of one of the parts of the coupling shaft in a horizontal plane, the free end of each of the arms of said fork being mounted rotating on a horizontal shaft transverse to the longitudinal axis of the coupling shaft and provided on two opposite lateral flanks of another part of the coupling shaft.

14. The coupling device according to claim 13, wherein the second pitch travel device further comprises a stiffening device that tends to return the two moving parts of the coupling shaft into the same longitudinal axis.

15. The coupling device according to claim 4, wherein the stiffening device comprises horizontal spring leaves fastened by an end on one of the moving parts of the coupling shaft, the free end of each of the spring leaves being received slidingly in a guide part provided on the other of the moving parts of the coupling shaft.

16. The coupling device according to claim 1, wherein second pitch travel device is provided in the proximal half of the coupling shaft.

17. The coupling device according to claim 1, wherein the first and second pitch travel devices each authorize a pitch travel of the road vehicle with which they are associated along a first horizontal axis and a second horizontal axis that are transverse to the longitudinal axis of the coupling shaft, these two axes being parallel and located in a same horizontal plane when the two coupled vehicles in turn travel on a same horizontal plane.

18. The coupling device according to claim 1, wherein the first road vehicle is a towing vehicle and in that the second road vehicle is a following vehicle.

19. A road vehicle provided to be coupled with another similar road vehicle by means of a coupling device according to claim 1 in order to form a road assembly comprising at least two vehicles, wherein each of the vehicles of said road assembly includes a coupling yoke at a front or rear end and a coupling shaft at the other, opposite end.

20. The road vehicle according to claim 19, wherein the road vehicle includes a coupling shaft in the front and a coupling yoke in the rear.
